(19) United States
(12) Patent Application Publication
(10) Pub. No.: US 2007/0085799 A1
(43) Pub. Date: Apr. 19, 2007

(54) LIQUID CRYSTAL DISPLAY APPARATUS, DEVICE OF DRIVNG THE SAME AND METHOD OF DRIVING THE SAME

(75) Inventors: Sung-Jin HONG, Seoul (KR); Cheol-Woo PARK, Suwon-si, Gyeonggi-do (KR); Chang-Hun LEE, Yongin-si, Gyeonggi-do (KR); Hee-Seop KIM, Hwaseong-si, Gyeonggi-do (KR); Jun-Woo LEE, Anyang-si, Gyeonggi-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/537,692

(22) Filed: Oct. 2, 2006

(30) Foreign Application Priority Data
Oct. 17, 2005 (KR) 10-2005-0097403

(51) Int. Cl. G09G 3/36

(52) U.S. Cl. 345/94

(57) ABSTRACT

A liquid crystal display panel includes a pixel having a switching element electrically connected to a gate wiring and a source wiring and a liquid crystal capacitor electrically connected to the switching element. A timing controller receives a mode selecting signal corresponding to an impulsive driving mode, and outputs a first common voltage corresponding to the impulsive driving mode. A common voltage converter converts the first common voltage into a second common voltage of analog type, and outputs the second common voltage to the liquid crystal capacitor. Therefore, in the LCD apparatus operated in an impulsive driving method, a common voltage is selectively applied to the liquid crystal display panel, thus improving a display quality.

This application claims priority to Korean Patent Application No. 2005-97403, filed on Oct. 17, 2005, and all the benefits accruing therefrom under 35 USC §119, the contents of which in its entirety are herein incorporated by reference.

### BACKGROUND OF THE INVENTION

1. Field of the Invention

The present invention relates to a liquid crystal display (“LCD”) apparatus, a device for driving an LCD apparatus and a method of driving an LCD apparatus. More particularly, the present invention relates to an LCD apparatus employing an impulsive driving method capable of improving an image display quality, a device for driving an LCD apparatus and a method of driving an LCD apparatus, both also employing an impulsive driving method.

2. Description of the Related Art

Recently, screen sizes and usage of LCD apparatuses have both increased as the LCD apparatus has improved its competitiveness over other display devices. Other display devices include, for example, a cathode ray tube (“CRT”) device, a plasma display panel (“PDP”) device, etc. Characteristics of the LCD apparatus, such as viewing angle, color reproducibility, capability of displaying a moving image, etc., have all been improved. In particular, the capability of displaying a moving image has greatly improved.

An impulsive driving method is performed to improve the display quality of a moving image. In the impulsive driving method, a black image is displayed after a normal image so that the black and normal images are displayed in one frame, thus necessitating employing a high-driving frequency. For example, an LCD apparatus displays sixty pictures per second, when the LCD apparatus is driven at 60 Hz. Therefore, an LCD apparatus employing the impulsive driving method displays one hundred twenty pictures per second because a black image is displayed after a normal image is displayed. As a result, an LCD apparatus requires a high-driving frequency equal to or more than about 120 Hz.

In the impulsive driving method, luminance and moving picture characteristics of a display change in accordance with a ratio of a normal image to a black image that are displayed in one frame period. For example, flickering phenomenon and after or residual image phenomenon may occur, which are induced by a kickback voltage.

### BRIEF SUMMARY OF THE INVENTION

The present invention provides a liquid crystal display (“LCD”) apparatus having an impulsive driving method capable of improving an image display quality.

The present invention also provides an apparatus for driving the above-mentioned LCD apparatus.

The present invention also provides a method of driving the above-mentioned LCD apparatus.

In one exemplary embodiment of the present invention, an LCD apparatus includes a liquid crystal display panel, a timing controller and a common voltage converter. The liquid crystal display panel includes a pixel having a switching element electrically connected to a gate wiring and a source wiring and a liquid crystal capacitor electrically connected to the switching element. The timing controller receives a mode selecting signal corresponding to an impulsive driving mode, and outputs a first common voltage corresponding to the impulsive driving mode. The common voltage converter converts the first common voltage into a second common voltage of analog type, and outputs the second common voltage to the liquid crystal capacitor.

In another exemplary embodiment of the present invention, a device for driving a LCD apparatus includes a first storage section, a control section and a common voltage converter. The above-mentioned LCD apparatus has a liquid crystal display panel including a pixel having a switching element electrically connected to a gate wiring and a source wiring and a liquid crystal capacitor electrically connected to the switching element. The first storage section stores a plurality of first common voltages corresponding to various impulsive driving modes. The control section reads out the first common voltage from the storage section in respond to a mode selecting signal. The common voltage converter converts the first common voltage into a second common voltage of analog type, and outputs the second common voltage to the liquid crystal capacitor.

In still another exemplary embodiment of the present invention, there is provided a method of driving a LCD apparatus. The above-mentioned LCD apparatus has a liquid crystal display panel including a switching element electrically connected to a gate wiring and a source wiring and a liquid crystal capacitor electrically connected to the switching element. In the method, a mode selecting signal corresponding to an impulsive driving mode is received from an external device. Then, a first common voltage that corresponds to the impulsive driving mode is converted into a second common voltage of analog type in response to the mode selecting signal. The second common voltage is then outputted to a liquid crystal capacitor.

According to the LCD apparatus, an apparatus and method of driving the LCD apparatus, wherein the LCD apparatus is operated in an impulsive driving method, a common voltage is selectively applied to the liquid crystal display panel, so that a display quality may be improved.

### BRIEF DESCRIPTION OF THE DRAWINGS

The above and other advantages of the present invention will become readily apparent by reference to the following detailed description when considered in conjunction with the accompanying drawings wherein:

FIG. 1 is an equivalent circuit schematic diagram showing a unit pixel of an LCD apparatus in accordance with an exemplary embodiment of the present invention;

FIG. 2 is a graph showing a relationship between a gradation voltage and a capacitance of a liquid crystal capacitor;

FIG. 3 is a block diagram showing an LCD apparatus according to an exemplary embodiment of the present invention;

FIG. 4 is a block diagram showing the timing controller in FIG. 3;

FIG. 5 is a flow chart showing a driving method of the LCD apparatus in FIG. 3;

FIG. 6 is a waveform diagram showing a driving method of an LCD apparatus in FIG. 3; and

FIGS. 7A to 7C are schematic diagrams showing impulsive driving modes according to an exemplary embodiment of the present invention.

### DETAILED DESCRIPTION OF THE INVENTION

The present invention will now be described more fully hereinafter with reference to the accompanying drawings, in which exemplary embodiments of the present invention are shown. This present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first thin film could be termed a second thin film, and, similarly, a second thin film could be termed a first thin film without departing from the teachings of the disclosure.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower,” therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, the present invention will be explained with reference to the accompanying drawings.

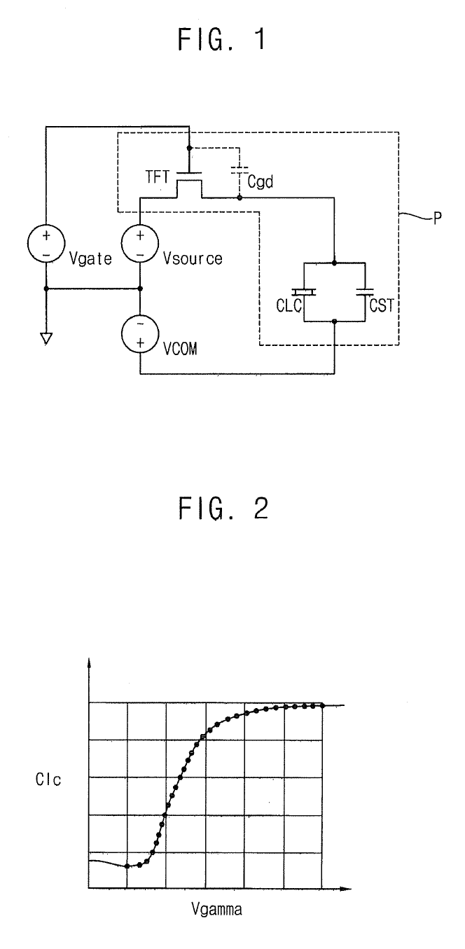

FIG. 1 is an equivalent circuit schematic diagram showing a unit pixel of an LCD apparatus in accordance with an exemplary embodiment of the present invention.

Referring to FIG. 1, a unit pixel P includes a switching element TFT, a liquid crystal capacitor CLC and a storage capacitor CST. The switching element TFT includes a gate electrode electrically connected to a gate wiring, a source electrode electrically connected to a source wiring and a drain electrode electrically connected to the liquid crystal capacitor CLC and the storage capacitor CST.

A gate voltage Vgate is applied to the gate electrode, and a source voltage Vsource, which is a data voltage, is applied to the source electrode. A pixel voltage corresponding to the source voltage Vsource is applied to the liquid capacitor CLC and the storage capacitor CST through the drain electrode. A parasitic capacitance Cgd induced by a parasitic capacitor exists between the gate electrode and the drain electrode. A common voltage VCOM is applied to a common electrode of the liquid capacitor CLC and a common electrode of the storage capacitor CST.

An amplitude of the kickback voltage (Vk) corresponding to the unit pixel P is defined by the following Equation 1:

$$Vk = \frac{Cgd}{Clc + Cst + Cgd } \times ( Von - Voff ) ,$$

wherein Von and Voff indicate a high level of the gate voltage Vgate and a low level of the gate voltage Vgate, respectively, Clc indicates a capacitance of the liquid crystal capacitor CLC, Cst indicates a capacitance of the storage capacitor and Cgd indicates a parasitic capacitance Cgd induced between the gate electrode and the drain electrode.

A source voltage Vsource that is applied to the liquid crystal capacitor CLC of the unit pixel P is different from another source voltage Vsource according to a gray level, thereby the kickback voltage Vk is also different from another according to the source voltage Vsource that is a gray voltage.

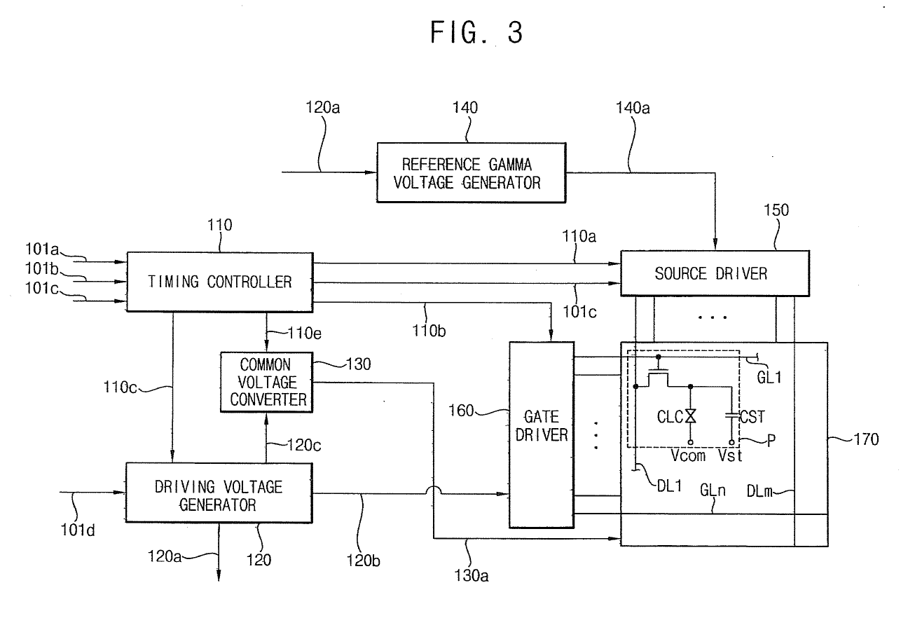

FIG. 2 is a graph showing a relationship between a gradation voltage and a capacitance of a liquid crystal capacitor.

Referring to FIG. 2 and Equation 1, a capacitance of the liquid crystal capacitor CLC changes as a gray voltage Vgamma is varied. That is, when the gray voltage Vgamma increases, a capacitance of the liquid crystal capacitor CLC gradually increases. When the capacitance of the liquid crystal capacitor CLC increases, the kickback voltage Vk gradually decreases as Equation 1 illustrates. That is, a kickback voltage Vk(63) in a gray voltage corresponding to a 63-gray scale, a kickback voltage Vk(32) in a gray voltage corresponding to a 32-gray scale and a kickback voltage Vk(0) in a gray voltage corresponding to a 0-gray scale have a relation such that Vk(63)<Vk(32)<Vk(0).

As described above, a kickback voltage Vk is changed in accordance with a gray voltage, so that a display quality of the liquid crystal display apparatus is deteriorated such as by a flickering phenomenon and a residual image.

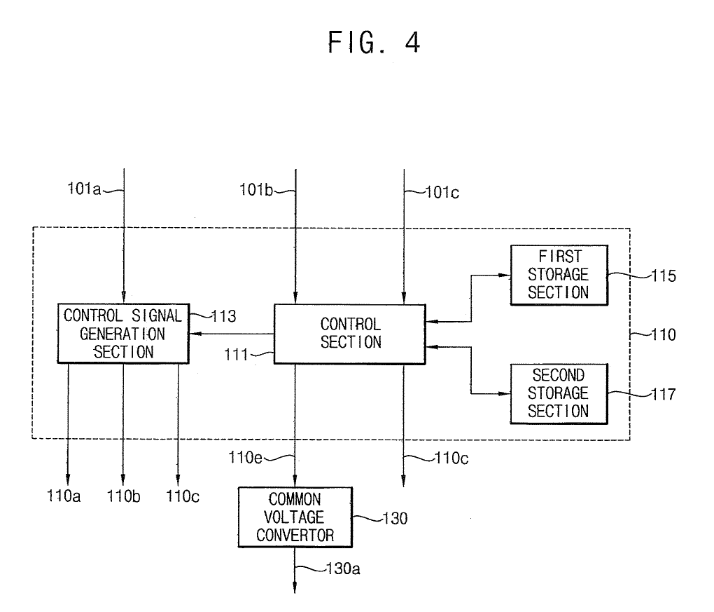

FIG. 3 is a block diagram showing an LCD apparatus according to an exemplary embodiment of the present invention.

Referring to FIG. 3, a liquid crystal display (“LCD”) apparatus includes a timing controller 110, a driving voltage generator 120, a common voltage converter 130, a reference gamma voltage generator 140, a source driver 150, a gate driver 160 and a liquid crystal display panel 170.

The timing controller 110 generates a first control signal 110a, a second control signal 110b and a third control signal 110c on a basis of a control signal 101a that is provided by an external device (not shown), and controls driving of the LCD apparatus. In order to control driving of the LCD apparatus, the first control signal 110a is applied to the source driver 150, the second control signal 110b is applied to the gate driver 160, and the third control signal 110c is applied to the driving voltage generator 120.

The timing controller 110 generates the second control signal 110c in response to a mode selecting signal 101b that is provided by the external device. The mode selecting signal 101b determines a display ratio of normal data to abnormal data that is displayed in a display area in one frame during an impulsive driving method. For example, in a first operating mode, the display ratio of the normal data to the abnormal data is set to be about 1:1, and in a second operating mode, the display ratio is set to be about 2:1. The mode selecting signal 101b is a signal for selecting predetermined display ratio among various display ratios, which is selected by a user.

The second control signal 110b includes at least two output enable signals that control an output of a gate signal. The output enable signals are generated on a basis of the mode selecting signal 101b.

The timing controller 110 provides the common voltage converter 130 with a digital common voltage 110e corresponding to the mode selecting signal 101b. For example, when the LCD apparatus is operated in the first operating mode, the timing controller 110 provides the common voltage converter 130 with a first common voltage VCOM_d1. When the LCD apparatus is operated in the second operating mode, the timing controller 110 provides the common voltage converter 130 with a common voltage VCOM_d2.

The timing controller 110 processes the data signal 101c that is provided by the external device, and provides the source driver 150 with the processed data signal 110c. In particular, the timing controller 110 receives the data signal 101c in response to a first driving frequency, and provides the source driver 150 with the processed data signal 101c in response to a second driving frequency that is generated by multiplying the first driving frequency by two.

The driving voltage generator 120 generates a driving voltage for driving the LCD apparatus by using an external power source 101d that is provided from an external device. In particular, the driving voltage generator 120 provides the reference gamma voltage generator 140 with an analog driving voltage (“AVDD”) 120a, and provides the gate driver 160 with a plurality of gate voltages 120b. The driving voltage generator 120 provides the common voltage converter 130 with a power voltage 120c for generating an analog common voltage.

The common voltage converter 130 converts the digital common voltage 110e that is provided by the timing controller 110 into an analog common voltage 130a, and provides the liquid crystal display panel 170 with the analog common voltage 130a.

The reference gamma voltage generator 140 generates ten to twenty reference gamma voltages 140a by using the AVDD 120a, and provides the source driver 150 with the reference gamma voltages 140a.

The source driver 150 converts the data signal 101c into an analog data voltage by using the reference gamma voltages 140a, and provides the liquid crystal display panel 170 with the analog data voltage.

Particularly, the source driver 150 provides the liquid crystal display panel 170 with a normal data voltage corresponding to a horizontal line during an earlier 1/2H time interval, and provides the liquid crystal display panel 170 with an abnormal data voltage corresponding to a horizontal line during a latter 1/2H time interval. Wherein, a 1H time interval is a time required for activating one gate wiring that forms the liquid crystal display panel 170. Alternatively, the source driver 150 provides the liquid crystal display panel 170 with an abnormal data voltage during an earlier 1/2H time interval, and provides the liquid crystal display panel 170 with a normal data voltage during a latter 1/2H time interval.

When the LCD apparatus corresponds to a normally white mode type, a level of the abnormal data voltage is higher than a level of the normal data voltage, which is a low gradation data voltage. For example, when a total gradation level has 256 gradations, the abnormal data voltage is a data voltage over at least 200th-gradations. The abnormal data voltage is a voltage corresponding to the black color or the gray color.

The gate driver 160 generates a plurality of gate signals by using a second control signal 110b that is provided by the timing controller 110 and a plurality of gate voltages 120b that are provided by the driving voltage generator 120, and provides the liquid crystal display panel 170 with the generated gate signals. The second control signal 110b includes at least two output enable signals.

The gate driver 160 sequentially outputs a plurality of gate signals to the liquid crystal display panel 170 in response to the output enable signals. Each of the output enable signals has a first control time interval and a second time interval. The gate driver 160 outputs a first gate pulse corresponding to the first control time interval to the liquid crystal display panel 170, and outputs a second gate pulse corresponding to the second control time interval to the liquid crystal display panel 170. Each of the gate signals has the first gate pulse and the second gate pulse.

The first gate pulse is a control signal through which the normal data voltage is applied to the liquid crystal display panel 170, and the second gate pulse is a control signal through which the abnormal data voltage is applied to the liquid crystal display panel 170. A time interval between the first gate pulse and the second gate pulse corresponding to a ratio of displaying the normal data to the abnormal data is displayed in a screen for one frame.

The liquid crystal display panel 170 includes a plurality of gate wirings GL1˜GLn, a plurality of source wirings DL1˜DLm and a plurality of pixels P that are electrically connected to the gate wiring and the source wiring. Each of the pixels P includes a switching element TFT, a liquid crystal capacitor CLC and a storage capacitor CST. The switching element TFT includes a gate electrode electrically connected to a gate wiring, a source electrode electrically connected to a source wiring and a drain electrode electrically connected to the liquid crystal capacitor CLC and the storage capacitor CST. An end portion of the liquid crystal capacitor CLC receives a common electrode voltage Vcom, and an end portion of the storage capacitor CST receives a storage voltage Vst. A level of the common electrode voltage Vcom is, for example, substantially equal to a level of the storage voltage Vst. Hereinafter, the common electrode voltage Vcom and the storage voltage Vst are referred to collectively as a common voltage VCOM.

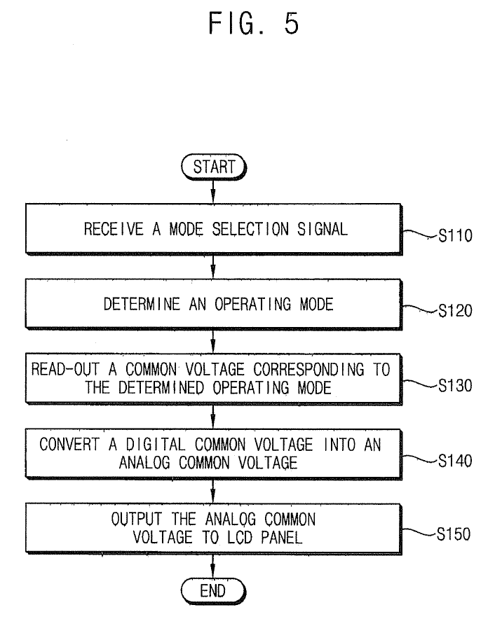

FIG. 4 is a block diagram showing the timing controller in FIG. 3.

Referring to FIGS. 3 and 4, the timing controller 110 includes a control signal generation section 111, a control section 113, a first storage section 115 and a second storage section 117.

The control signal generation section 111 controls a total driving operation of the timing controller 110.

The control signal generation section 111 generates a first control signal 110a, a second control signal 110b and a third control signal 110c on a basis of a control signal 101a that is provided by the control section 111. The control section 111 controls the control signal generation section 113 on a basis of the mode selecting signal 101b. In particular, the control signal generation section 113 generates a first control signal 110a for high speed driving of the source driver 150, and outputs the first control signal 110a to the source driver 150. Moreover, the control signal generation section 113 outputs the second control signal 110b in response to the mode selecting signal 101b.

The control signal 101a includes a main clock signal (MCLK), a horizontal synchronizing signal (HSYNC), a vertical synchronizing signal (VSYNC) and a data enable signal (DE). The vertical synchronizing signal (VSYNC) indicates a beginning of a frame field. The horizontal synchronizing signal (HSYNC) indicates a beginning of a next scan line of the frame field. Thus, the horizontal synchronizing signal (HSYNC) includes pulses corresponding to the number of pixels included in one line. The data enable signal (DE) indicates supplying the pixel with data. The first control signal 110a includes a horizontal start signal (STH) and a load signal (TP). The second control signal 110b includes a vertical start signal (or scan start signal; STV), a scan clock signal (CPV) and at least two output enable signals (OE1 and OE2). The third control signal 110c includes a main clock signal MCLK.

The first storage section 115 stores the data 101b in a prescribed unit, more preferable in a unit of horizontal line. The control section 111 stores the data 101b in the storage section 115. The control section 111 reads out the stored data 101b in a unit of horizontal lines from the first storage section 115, and outputs the read-out data 101b to the source driver 150.

For example, the control section 111 applies the data 101b that is inputted in a first driving frequency to the first storage section 115, and reads out the stored data 101c from the first storage section 115 in a second driving frequency that is generated by multiplying the first driving frequency by two. The control section 111 applies the read-out data 101c to the source driver 150. Therefore, the source driver 150 outputs a normal data voltage and an abnormal data voltage to the liquid crystal display panel 170 during a 1H time interval. The normal data voltage and the abnormal data voltage correspond to a horizontal line of the liquid crystal display panel 170.

A plurality of common voltages corresponding to various impulsive operating modes is stored in the second storage section 117. The operating mode is determined by a display ratio of the normal data to the abnormal data that are displayed in the display area in one frame during an impulsive driving.

The control section 111 reads out a common voltage 110e corresponding to the inputted mode selecting signal 101b, and outputs the common voltage 110e to the common voltage converter 130. That is, the common voltages that are stored in the second storage section 117 in the various operating modes are a digital type data. The control section 111 and the common voltage converter 130 are communicated to each other by using a I²C bus type, and transmitting and receiving the digital common voltage 110e corresponding to the mode selecting signal 101b.

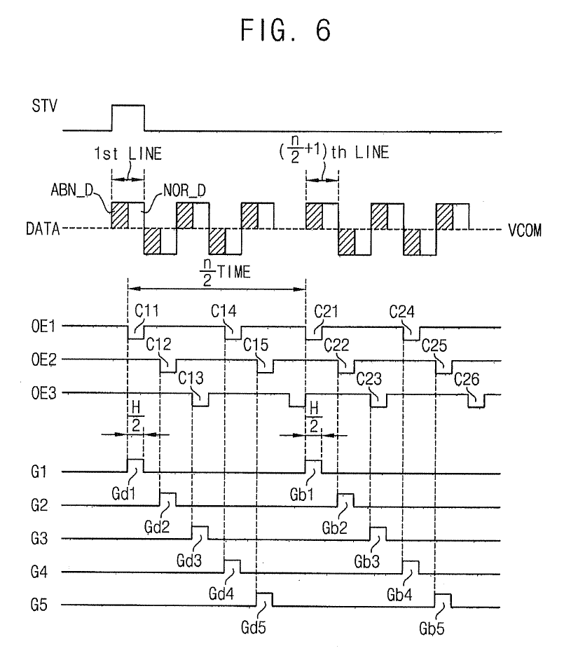

FIG. 5 is a flow chart showing a driving method of the LCD apparatus in FIG. 3 in accordance with an exemplary embodiment of the present invention. The following Table 1 shows a data structure for illustrating a driving method in FIG. 5.

TABLE 1

| | Mode | | |
|---|---|---|---|
| | selecting | Digital common | Analog common |
| NOR_D:ABN_D | signal | voltage | voltage |
| 1:1 | 1 | VCOM_d1 | VCOM_a1 |
| 2:1 | 2 | VCOM_d2 | VCOM_a2 |
| 3:1 | 3 | VCOM_d3 | VCOM_a3 |
| 4:1 | 4 | VCOM_d4 | VCOM_a4 |
| 5:1 | 5 | VCOM_d5 | VCOM_a5 |

Referring to FIGS. 3 to 5 and Table 1, the control section 111 receives a mode selecting signal 101b from an external device (not shown) (step S110). When the mode selecting signal 101b is set to be ‘2’, the control section 111 determines an operating mode of the current LCD apparatus by using the received mode selecting signal 101b (step S120). For example, the control section 111 determines whether the operating mode corresponding to the mode selecting signal ‘2’ indicates that a display ratio of a normal data (“NOR”) to an abnormal data (“ABN”) is about 2:1.

The control section 111 reads out a common voltage corresponding to the determined operating mode from the second storage section 117 (step S130). For example, the control section 111 reads out a digital common voltage (VCOM_d2) from the second storage section 117, which corresponds to an operating mode in which a display ratio of a normal data (“NOR”) to an abnormal data (“ABN”) is about 2:1.

The control section 111 outputs the read-out digital common voltage to the common voltage converter 130. The common voltage converter 130 converts the digital common voltage into an analog common voltage (step S140).

The common voltage converter 130 outputs the analog common voltage to the liquid crystal display panel 170 (step S150).

For example, the control section 111 reads out the digital common voltage VCOM_d2 corresponding to an operating mode in which an NOR:ABN is set to be about 2:1 to the common voltage converter 130. The control section 111 and the common voltage converter are connected to each other by using an I²C bus, and transmit and receive the digital common voltage VCOM_d2. The common voltage converter 130 converts the digital common voltage VCOM_d2 into an analog common voltage VCOM_a2. The common voltage converter 130 outputs the analog common voltage VCOM_a2 to the liquid crystal display panel 170.

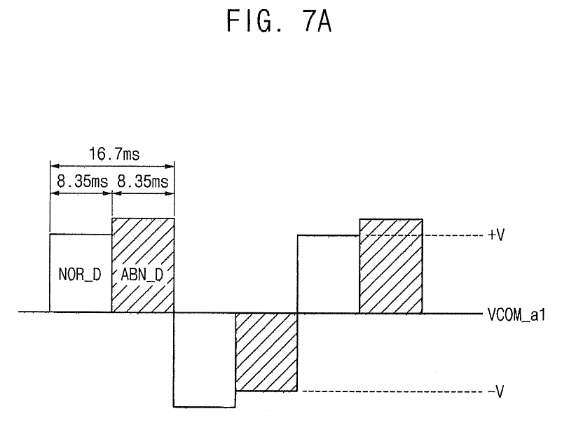

FIG. 6 is a waveform diagram showing a driving method of the LCD apparatus in FIG. 3. Hereinafter, an impulsive driving mode having a display ratio of a normal data (“NOR”) to an abnormal data (“ABN”) is about 2:1 will be described.

Referring to FIGS. 3 to 6, the timing controller 110 outputs a first control signal 110a, a second control signal 110b and a third control signal 110c for controlling the driving voltage generator 120, the source driver 150 and the gate driver 160, respectively, on a basis of the control signal 101a and mode selecting signal 101b.

The timing controller 110 outputs a first control signal 110a and a second control signal 110b on a basis of the mode selecting signal 101b. The timing controller 110 outputs a data signal 101c of a horizontal line that is stored in the first storage section 115 during about an 1/2H time interval. The source driver 150 outputs a normal data voltage to the source wirings DL1˜DLm of the liquid crystal display panel 170 on a basis of the first control signal 110a during an earlier 1/2H time interval.

Alternatively, the gate driver 160 outputs n-number of gate signals G1˜Gn to gate wirings GL1˜GLn of the liquid crystal display panel 170, respectively on a basis of the second control signal 110b.

Particularly, the second control signal 110b includes a scan start signal STV, a first output enable signal OE1, a second output enable signal OE2 and a third output enable signal OE3. A (3k−2)-th gate signals G1, G4, . . . , and Gn-2 are outputted to (3k−2)-th gate wirings GL1, GL4, . . . and GLn-2 of the liquid crystal display panel 170 on a basis of the first output enable signal OE1, and a (3k−1)-th gate signals G2, G5, . . . , and Gn-1 are outputted to (3k−1)-th gate wirings GL2, GL5, . . . and GLn-1 of the liquid crystal display panel 170 on a basis of the second output enable signal OE2. A (3k)-th gate signal G3, G6, . . . , and Gn are outputted to (3k)-th gate wirings GL3, GL6, . . . and GLn of the liquid crystal display panel 170 on a basis of the third output enable signal OE3, wherein ‘k’ is a natural number.

The first to third output enable signals OE1, OE2 and OE3 include a first control period C1k and a second control period C2k, wherein k is a natural number. The first control period C1k is separated from the second control period C2k by as much as the first gate pulse is separated from the second gate pulse.

The first control period C1k corresponds to a time interval during which a normal data voltage NOR_D is outputted from the source driver 150. The first control period C1k corresponds to a first gate pulse Gdk of a gate signal outputted from the gate driver 160, wherein k is a natural number. The second control period C2k corresponds to a time interval during which an abnormal data voltage ABN_D is outputted from the source driver 150. The second control period C2k corresponds to a second gate pulse Gbk of a gate signal outputted from the gate driver 160, wherein k is a natural number.

For example, the first gate signal G1 has a first gate pulse Gd1 and a second gate pulse Gb1. A normal data voltage is stored in a first horizontal line in response to the first gate pulse Gd1, and an abnormal data voltage is stored in ((n/2)+1)-th horizontal line in response to the second gate pulse Gb1.

The first gate pulse Gdk of each of the gate signals G1, G2, . . . , and Gn controls charging of a normal data voltage to the liquid crystal display panel, and the second gate pulse Gbk of each of the gate signals G1, G2, . . . , and Gn controls charging of an abnormal data voltage to the liquid crystal display panel 170. Therefore, a display ratio of a normal data to an abnormal data that is displayed in the liquid crystal display panel 170 is set to be about 1:1.

The timing controller 110 determines a current impulsive driving mode on a basis of the mode selecting signal 101b, and reads out a digital common voltage VCOM_d1 corresponding to the determined current impulsive driving mode from the second storage section 117. The timing controller 110 converts the read-out digital common voltage VCOM_d1 into an analog common voltage VCOM_a1, and outputs the analog common voltage VCOM_a1 to the liquid crystal display panel 170.

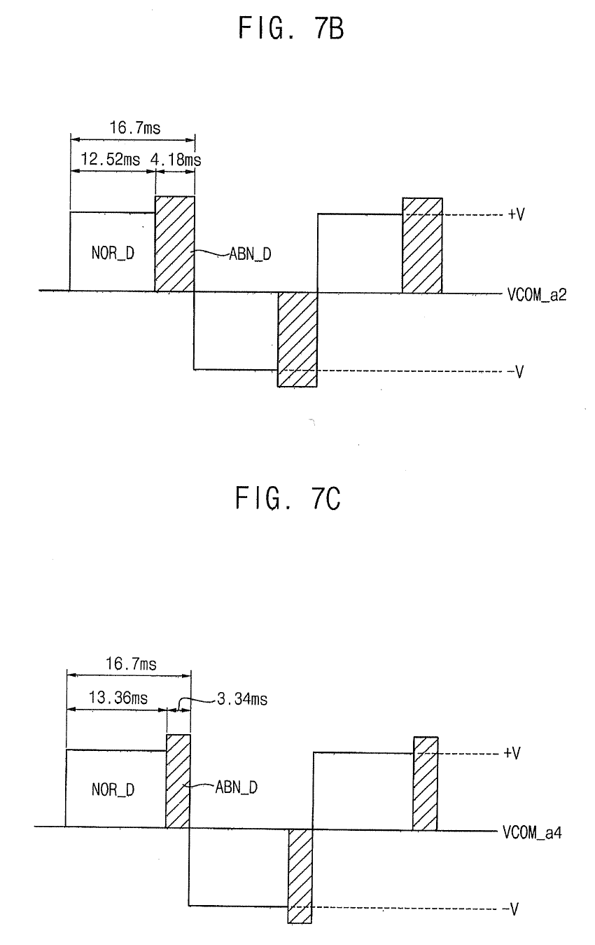

FIGS. 7A to 7C are schematic diagrams showing impulsive driving modes according to an exemplary embodiment of the present invention. Hereinafter, one frame period will be explained as 16.7 ms.

In FIGS. 6 and 7A, and Table 1, a time separation gap between a first control period and a second control period of the output enable signal or a time separation gap between a first gate pulse and a second gate pulse of the gate signal is ½ frame period.

As shown above, a source driver outputs a normal data voltage to the liquid crystal display panel during ½ frame period (about 8.35 ms), and outputs an abnormal data voltage to the liquid crystal display panel during the remaining ½ frame period (about 8.35 ms). A display ratio of a normal image to an abnormal image that is displayed in a display area of one frame is about 1:1. A first common voltage VCOM_a1 is outputted to the liquid crystal display panel.

In FIG. 7B, a time separation gap between a first control period and a second control period of the output enable signal or a time separation gap between a first gate pulse and a second gate pulse of the gate signal is ⅔ frame period. As shown above, a source driver outputs a normal data voltage to the liquid crystal display panel during ⅔ frame period (about 12.52 ms), and outputs an abnormal data voltage to the liquid crystal display panel during the remaining ⅓ frame period (about 4.18 ms). A display ratio of a normal image to an abnormal image that is displayed in a display area of one frame is about 3:1. A second common voltage VCOM_a2 is outputted to the liquid crystal display panel.

In FIG. 7C, a time separation gap between a first control period and a second control period of the output enable signal or a time separation gap between a first gate pulse and a second gate pulse of the gate signal is ⅘ frame period. As shown in above, a source driver outputs a normal data voltage to the liquid crystal display panel during ⅘ frame period (about 13.36 ms), and outputs an abnormal data voltage to the liquid crystal display panel during the remaining ⅕ frame period (about 3.34 ms). A display ratio of a normal image to an abnormal image that is displayed in a display area of one frame is about 4:1. A fourth common voltage VCOM_a4 is outputted to the liquid crystal display panel.

The following Table 2 and Table 3 show experimental data that illustrate enhanced luminance characteristics of the LCD apparatus according to an exemplary embodiment of the present invention.

Table 2 shows black luminance characteristics when the LCD apparatus is driven at various impulsive driving modes, with an applied optimized common voltage VCOM.

TABLE 2

| | NOR_D:ABN_D | | | | |
|---|---|---|---|---|---|
| | 1:1 | 2:1 | 3:1 | 4:1 | 5:1 |
| Black luminance | 2.18 | 2.11 | 2.07 | 2.05 | 2.03 |

Referring to Table 2, in various impulsive driving modes, when a display ratio of a normal data NOR_D to an abnormal data ABN_D was about 1:1, 2:1, 3:1, 4:1 and about 5:1, black luminance characteristics was observed to be about 2.18 [cd/m²], 2.11 [cd/m²], 2.07 [cd/m²], 2.05 [cd/m²] and about 2.03 [cd/m²], respectively.

That is, although the optimized common voltage VCOM was applied in each of the impulsive driving modes, as a display ratio of an abnormal image that is induced by a flickering is increased, a black luminance is also increased. Therefore, a problem such as a decreasing of a contrast ratio (“CR”) and an after-image that is induced by a charging of a direct current (“DC”) occurs in the LCD apparatus.

Alternatively, Table 3 shows black luminance characteristics when the LCD apparatus is driven at various impulsive driving modes, and with a plurality of applied optimized common voltages VCOM that are different from each other.

TABLE 3

| | NOR_D:ABN_D | | | | |
|---|---|---|---|---|---|
| | 1:1 | 2:1 | 3:1 | 4:1 | 5:1 |
| Black luminance | 2.06 | 2.05 | 2.04 | 2.05 | 2.03 |

Referring to Table 3, in various impulsive driving modes, when a display ratio of a normal data NOR_D to an abnormal data ABN_D was about 1:1, 2:1, 3:1, 4:1 and about 5:1, black luminance characteristics was observed to be about 2.06 [cd/m²], 2.05 [cd/m²], 2.04 [cd/m²], 2.05 [cd/m²] and about 2.03 [cd/m²], respectively.

When the optimized common voltage VCOM was applied to each of the impulsive driving modes, the display ratio of the abnormal image was increased, however a black luminance does not also increase. That is, a luminance distribution was uniform using the various impulsive driving modes.

According to the present invention, optimized common voltages corresponding to various impulsive driving modes was stored in an LCD apparatus, and an optimized common voltage corresponding to present impulsive driving mode is selectively applied to the LCD apparatus. Therefore, a display quality of the LCD apparatus is enhanced in an impulsive driving mode.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A liquid crystal display (LCD) apparatus comprising:
a liquid crystal display panel including a pixel having a switching element electrically connected to a gate wiring and a source wiring, and a liquid crystal capacitor electrically connected to the switching element;
a timing controller receiving a mode selecting signal corresponding to an impulsive driving mode, and outputting a first common voltage corresponding to the impulsive driving mode; and
a common voltage converter converting the first common voltage into a second common voltage of analog type, and outputting the second common voltage to the liquid crystal capacitor.

2. The LCD apparatus of claim 1, wherein the pixel further comprises a storage capacitor electrically connected to the liquid crystal capacitor, and the common voltage converter outputs the second common voltage to the storage capacitor.

3. The LCD apparatus of claim 1, wherein the timing controller further comprises:
a storage section storing a plurality of first common voltages corresponding to various impulsive driving modes; and
a control section reading out the first common voltages from the storage section in response to the mode selecting signal.

4. The LCD apparatus of claim 3, wherein the timing controller further comprises a control signal generation section which generates a first control signal and a second control signal on a basis of a control signal provided by an external device.

5. The LCD apparatus of claim 4, further comprising:
a source driver outputting an abnormal data signal to the liquid crystal display panel during a first time interval in response to the first control signal, and outputting a normal data signal to the liquid crystal display panel during a second time interval in response to the first control signal; and
a gate driver outputting a gate signal having a first gate pulse corresponding to the second time interval and a second gate pulse corresponding to the first time interval to the liquid crystal display panel in response to the second control signal to the liquid crystal display panel.

6. The LCD apparatus of claim 5, wherein each of the first and second time intervals is about a 1/2H time interval, in which a 1H time interval is a time required for activating one gate wiring.

7. The LCD apparatus of claim 5, wherein the control section regulates a time interval between the first gate pulse and the second gate pulse on a basis of the mode selecting signal.

8. The LCD apparatus of claim 5, wherein the abnormal data signal is a low gradation data voltage signal that is lower than the normal data signal.

9. A device of driving a liquid crystal display (LCD) apparatus having a liquid crystal display panel including a pixel having a switching element electrically connected to a gate wiring and a source wiring and a liquid crystal capacitor electrically connected to the switching element, the driving apparatus comprising:
a first storage section storing a plurality of first common voltages corresponding to various impulsive driving modes;
a control section reading out the first common voltage from the storage section in response to a mode selecting signal; and
a common voltage converter converting the first common voltage into a second common voltage of analog type, and outputting the second common voltage to the liquid crystal capacitor.

10. The device of claim 9, wherein the pixel further comprises a storage capacitor electrically connected to the liquid crystal capacitor, and the common voltage converter outputs the second common voltage to the storage capacitor.

11. The device of claim 9, further comprising:
a control signal generation section generating a first control signal and a second control signal in response to a control signal provided by an external device on a basis of the mode selecting signal;
a source driver outputting an abnormal data signal to the liquid crystal display panel during a first time interval in response to the first control signal, and outputting a normal data signal to the liquid crystal display panel during a second time interval in response to the first control signal; and
a gate driver outputting a gate signal having a first gate pulse corresponding to the second time interval and a second gate pulse corresponding to the first time interval to the liquid crystal display panel in response to the second control signal to the liquid crystal display panel.

12. The device of claim 11, wherein the control signal generation section outputs a second control signal that controls the gate driver to separate the first gate pulse from the second gate pulse in response to the mode selecting signal.

13. The device of claim 11, further comprising: a second storage section that stores a normal data,
wherein the control signal generation section outputs a first control signal that controls the source driver to output a normal data signal of a unit of a horizontal line to the source driver in response to the mode selecting signal, which is stored in the second storage section.

14. The device of claim 13, wherein the source driver converts the normal data signal into an analog normal data voltage, outputs the analog data voltage to the liquid crystal display panel during the 1/2H time interval, and outputs the abnormal data signal to the liquid crystal display panel during the remaining 1/2H time interval, in which the 1H time interval is a time required for activating one gate wiring.

15. The device of claim 9, wherein the abnormal data voltage corresponds to a black gradation data voltage.

16. A method of driving a liquid crystal display (LCD) apparatus having a switching element electrically connected to a gate wiring and a source wiring and a liquid crystal capacitor electrically connected to the switching element, the method comprising:
receiving a mode selecting signal corresponding to an impulsive driving mode from an external device;
converting a first common voltage which corresponds to the impulsive driving mode into a second common voltage of analog type in response to the mode selecting signal; and
outputting the second common voltage to the liquid crystal capacitor.

17. The method of claim 16, further comprising:
generating a first control signal and a second control signal in response to the mode selecting signal;
applying an abnormal data voltage and a first gate pulse for charging the abnormal data voltage to the source wiring and the gate wiring, respectively, during a first time interval in response to the first control signal; and
applying a normal data voltage and a second gate pulse for charging the normal data voltage to the source wiring and the gate wiring, respectively, during a second time interval in response to the second control signal.

18. The method of claim 17, wherein a separating distance between the first gate pulse and the second gate pulse is set by the mode selecting signal.

19. The method of claim 18, wherein the normal data voltage is charged in the liquid crystal capacitor in response to the first gate pulse, and the abnormal data voltage is charged in the liquid crystal capacitor in response to the second gate pulse.

20. The method of claim 17, wherein the first and second time intervals are each set to be a 1/2H time interval, respectively, wherein the 1H time interval is a time required for activating one gate wiring.
